(19) United States
(12) Patent Application Publication
(10) Pub. No.: US 2008/0078850 A1
(43) Pub. Date: Apr. 3, 2008

(54) SPREADER DEFLECTION PLATE APPARATUS AND METHOD

(75) Inventor: Neil Edwin Bowsher, Sullivan, IL (US)

Correspondence Address: VEDDER PRICE KAUFMAN & KAMMHOLZ, 222 N. LASALLE STREET, CHICAGO, IL, 60601, US

(73) Assignee: Agri-Fab, Inc., Sullivan, IL (US)

(21) Appl. No.: 11/532,397

(22) Filed: Sep. 15, 2006

(51) Int. Cl. A01C 17/00

(52) U.S. Cl. 239/687; 239/681

(57) ABSTRACT

The present disclosure relates to an improved broadcast deflector plate designed to create a cascade-like deflection of material over a series of angled tabs separated by open intervals where indirect flow is created. A first volume of material falls without deflection directly through the open intervals onto the spreader plate at a first position, and a second volume of material is deflected by the tabs to a preferential location closer to the center of the spreader plate at a second position, the presence of the openings between the tabs allowing for a third volume of material to cascade in all directions around the tabs and reach all intermediate positions on the spreader plate.

### FIELD OF THE DISCLOSURE

The present disclosure relates to the spreading system of broadcast spreaders for seeds, granular material, and other loose material, and in particular, to an improved spreader deflection plate apparatus and method to better distribute the seeds, granular materials, and other loose materials on a surface.

### BACKGROUND

Broadcast spreaders are used to disperse seeds, granular material, and other loose material (hereinafter, “material”) over a surface. A large volume of material to be dispersed, generally purchased in a bag or canister, is emptied into a receptacle called a hopper. Portable broadcast spreaders may be operated manually by a single user by pushing the device equipped with wheels, a frame, and a handle bar.

In order to spread material over a surface, broadcast spreaders are equipped with distribution systems generally located under the hopper when gravity is the driving force behind the flow of the material through the distribution system. A variable area of the bottom opening in the hopper is controlled by the user to regulate the flow of material in the distribution system.

Some distribution systems, such as a chalk line machine used on sports fields, distribute the flow of material along a line of variable width, while other distribution systems for grass seed spread material over an area around the machine. Examples of portable broadcast spreaders include conventional fertilizer dispensers and seed dispensers.

Distribution systems are further equipped with a spreading device to propel the material flowing through the bottom opening to a surface area of desired size. Some broadcast spreaders have a rotating spreader plate with grooves and ribs activated by the wheel movement force. The faster the broadcast spreader is moved, the faster the broadcast spreader plate rotates, and the farther are seeds sent.

The distribution system is also equipped with a deflection device designed to redirect the flow of material from the bottom opening to the spreading device. A first problem with conventional deflection systems is that they must be able to deflect material appropriately at any setting of the aperture at the bottom opening selected by the user. The deflection device must also maintain a proper level of deflection even when the supply of material in the hopper decreases and the flow of material decreases. In some instances, material may be flowing only in the center portion of the bottom opening or may be flowing preferentially from the lateral portions of the bottom opening. The deflection plate must maintain adequate deflective capacity under these possible conditions of operation.

Broadcast spreaders equipped with a rotating spreader plate present additional problems not addressed in the prior art. Material falling on a round, rotating spreader plate change direction and are propelled by the local centrifugal force on the plate and the material interacts with the ribs on the surface of the plate. If most of the material is deflected from the spreader plate at a certain speed and trajectory, most of the material is distributed at a consistent radius around the broadcast spreader. An ideal broadcast spreader would spread material uniformly over the ground and without depositing more material at a certain distance from the broadcast spreader.

Deflection plates in the prior art do not address any of these problems. U.S. Pat. No. 4,867,381 shows a system where a reverse V-shaped plate is used to deflect the material from a hopper. The material falls on the deflection plate and is simply redirected to a new position after a lateral translation. The invention does not offer better distribution of the material over the entire surface of the spreader plate since it only redirects the flow of material to a different position on the spreader plate. Another deflection plate for a broadcast spreader from the prior art is shown as FIG. 1. This figure illustrates the SPYKER™ push spreader model 98-22. This device includes a reverse V-shaped plate at two variable angles along the length. The problem with this device relates to the deflection on the spreader plate at two distinct radii.

Therefore, there is a need in the art for new improved deflector plate assembly and method of use thereof that deflects material uniformly from the rotating spreader plate without deflecting the material to fixed distances from the broadcast spreader.

### SUMMARY

The present disclosure relates to an improved broadcast deflector plate designed to create a cascade-like deflection of material over a series of angled tabs separated by open intervals where indirect flow is created. A first volume of material falls without deflection directly through the open intervals onto the spreader plate at a first position, and a second volume of material is deflected by the tabs to a preferential location closer to the center of the spreader plate at a second position. The presence of the openings between the tabs allowing for a third volume of material to cascade in all directions around the tabs and reach all intermediate positions on the spreader plate.

The disclosure relates to a new broadcast spreader, a new broadcast deflector plate, and a method of use thereof, equipped with a deflection plate where a series of angled tabs are made in the periphery of an opening. The tabs are of sufficient length and width in proportion to the intervals between tabs to create a cascade effect of material in order to effectively deflect material uniformly over the spreader plate.

### BRIEF DESCRIPTION OF THE DRAWINGS

Certain embodiments are shown in the drawings. However, it is understood that the present disclosure is not limited to the arrangements and instrumentality shown in the attached drawings.

FIG. 1 is an exploded view of the prior art deflection system of the SPYKER™ push spreader model 98-22.

FIG. 2 is a partly exploded perspective view of the broadcast spreader and the spreader deflection plate and apparatus according to the present disclosure.

FIG. 3 is an exploded perspective view of the deflector plate assembly according to the embodiment of FIG. 2.

FIG. 4 is a perspective view of the deflector plate assembly of FIG. 3.

FIG. 5 is a partial upper side functional 3D view of the deflector plate assembly used to illustrate the particularities of the deflection plate of the broadcast spreader of FIG. 2.

FIG. 6 is a flow chart that schematically illustrates the steps of the method for uniform spreading of material over a horizontal surface using a broadcast spreader and a deflection plate as described in FIG. 2.

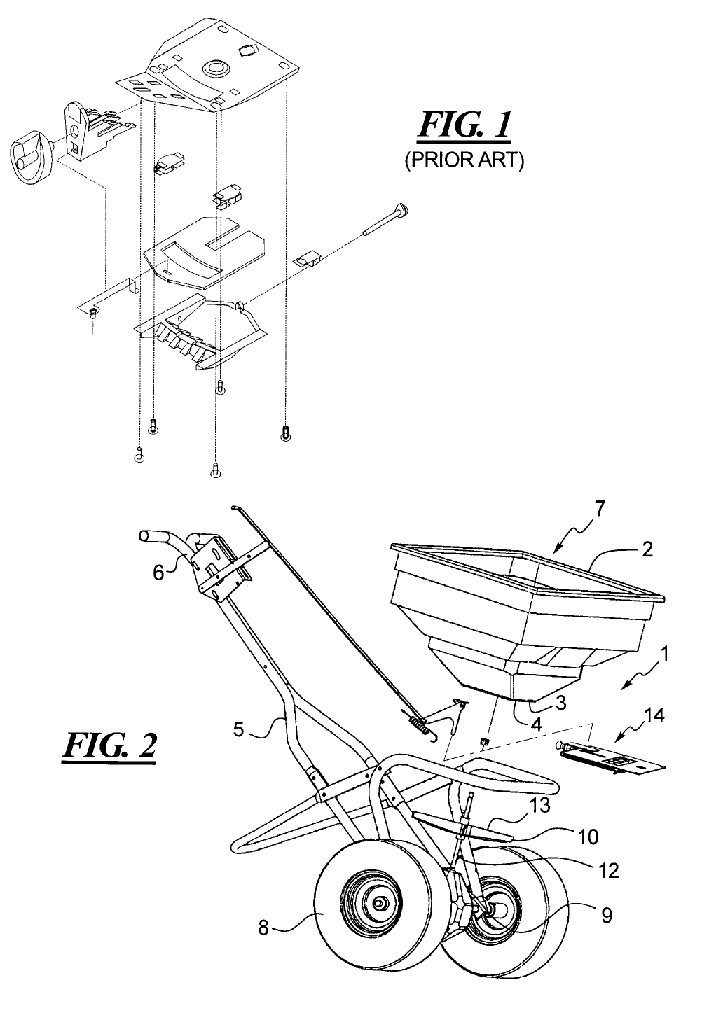

### DETAILED DESCRIPTION

For the purposes of promoting and understanding the principles disclosed herein, reference will now be made to the preferred embodiments illustrated in the drawings and specific language will be used to describe the same. It will nevertheless be understood that no limitation of the scope is thereby intended. Such alterations and further modifications in the illustrated devices and such further applications of the principles disclosed as illustrated herein as being contemplated as would normally occur to one skilled in the art to which this disclosure relates.

FIG. 2 of the present disclosure relates to a broadcast spreader 1 made of a hopper 2 having a bottom opening 3 with a periphery 4. The broadcast spreader 1 further comprises a frame 5 for supporting the hopper 2. In a preferred embodiment, the frame 5 includes a handle 6 for operating the broadcast spreader 1. It is understood by one of ordinary skill in the art that while a hopper 2 made of a rectangular volumetric shape is disclosed, any shape of container or hopper 2 made of metal, plastic, or any other formable material of any geometry able to form a container for seeds, granular material, and other loose material 7 (“material”) is contemplated. While material 7 is generally purchased in a bag or canister to be emptied into the hopper 2 by a user, the present disclosure also contemplates the use of a broadcast spreader where the material 7 is a rigid or partly rigid body contained in a bag or canister of material 7 that may itself be used as the hopper 2 or in conjunction with an interface on the frame 5 to be attached to the bag or canister of material 7.

The broadcast spreader 1 also comprises a wheel 8 attached rotatably to the frame 5 by an axle 9 for movement of the broadcast spreader 1 across a surface (not shown) such as soil, grass, roads, and the like. In one embodiment shown in FIG. 2, two wheels 8 are attached to the frame supported by a horizontal axle 9. It is understood that any regular means of ground transportation of a small device may be used in association with a combination of wheels, frames, or rotational axles. The broadcast spreader 1 is further equipped with a rotatable spreader plate 10 located below the hopper 2 to spread the material 7. In the embodiment shown in FIG. 2, the rotatable spreader plate 10 is functionally connected to the horizontal axle 9 via a series of gears (not shown) protected by a cover 11. In one embodiment, when the user pushes the broadcast spreader 1 along a surface, the wheels are functionally connected to the axle 9 whereby linear movement of the spreader translates rotational motion to the axle 9. One gear (not shown in detail) is attached to the axle 9 and another gear (not shown in detail) is connection to another axle 12 for meshing engagement such that rotational movement of axle 9 is translated to axle 12. The other end of axle 12 is connected to the rotatable spreader plate 10. The spreader plate shown in FIG. 2 is equipped with surface ribs 13. It is understood by one of ordinary skill in the art that, while a gear system (not shown, but described herein) facilitates rotation of the spreader plate 10 of flat, square geometry, any type of rotation device, either mechanical or electrical, able to rotate the spreader plate is contemplated.

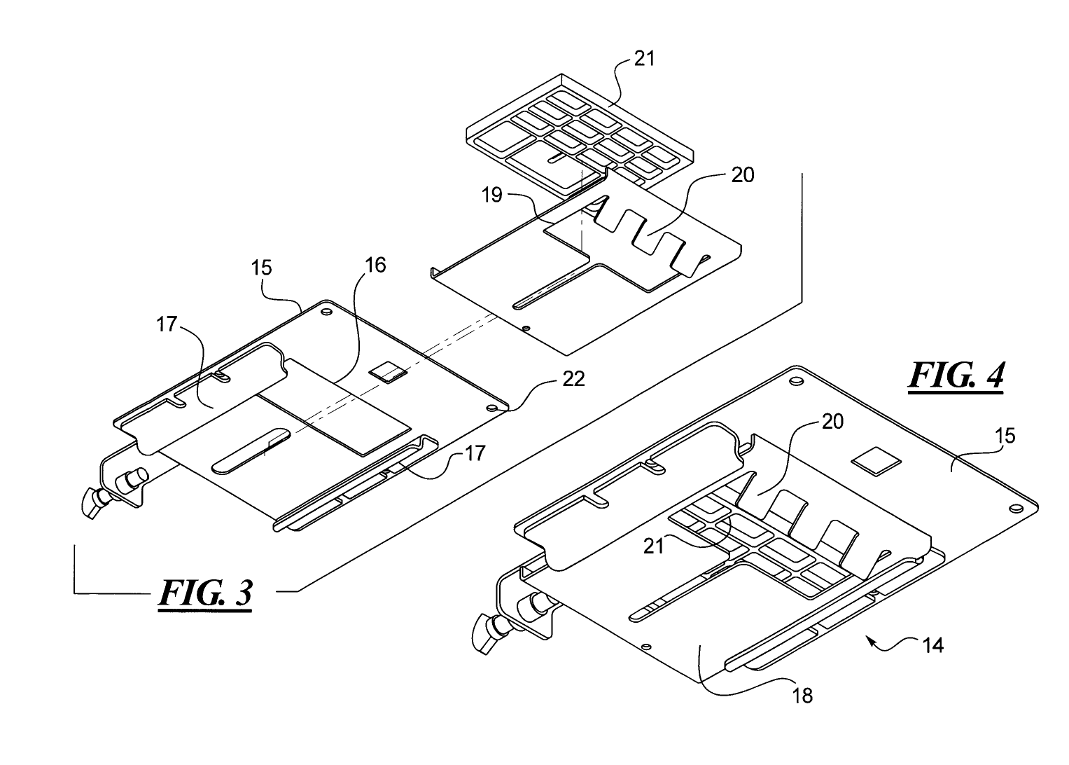

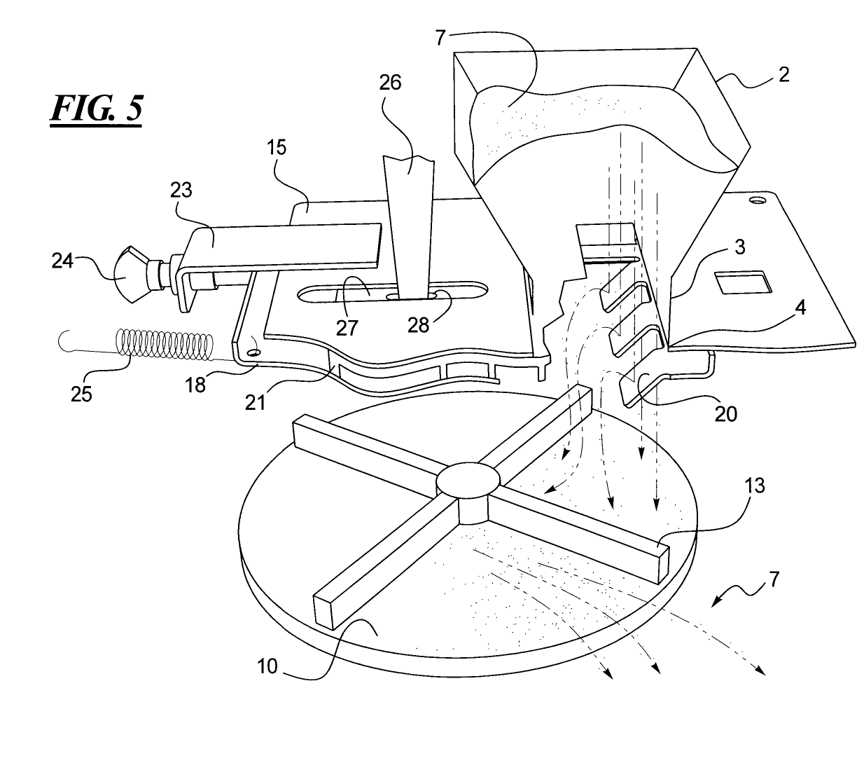

The broadcast spreader 1 further comprises a deflection plate assembly 14 shown in detail in FIGS. 3-4. The deflection plate assembly 14 includes a guide plate 15 with a flow opening 16 and a guide 17. The guided plate 15 is connected to the periphery of the bottom opening 3 as partly shown in FIG. 2. Returning to FIG. 3, a pattern plate including a deflection opening 19 is inserted in the guide 16. The deflection opening 19 has peripheral angled tabs 20. A closure plate 21 is inserted within the deflection plate assembly 14. In the embodiment shown in FIG. 3, the guide 17 on the guide plate 15 is made of two L-shaped rails located on each side of the flow opening 16. The guide plate 15 is secured to the hopper 2 by four corner fixation bolts (not shown) in fixation holes 22 located between the guide plate and the pattern plate. The closure plate 21 in one embodiment is encased within the guide plate 15 and the pattern plate 18. It will be understood by one of ordinary skill in the art that the closure plate 21 serves to vary the opening of the hopper bottom 3. Possible embodiments of an opening variation mechanism are shown in FIGS. 2 and 5.

The broadcast spreader 1 is equipped with a U-shaped tab 26 attached at the bottom of the U on the hopper 2. One branch of the U is secured to the handle 6 and the other branch is inserted to operatively connect the closure plate 21. The closure plate 21 is moved over the flow opening 16 to control the flow of material 7 from the hopper 2 through the bottom opening 3, the flow opening 16, and the deflection opening 19 onto the rotatable spreader plate 10. In an embodiment shown in FIG. 5, the closure plate 21 is moved over the flow opening 16 with the help of a manually operated U-shaped tab 26 moving in a slot 27. The movement of the closure plate 21 is also limited by the position of the pattern plate 18 under the bottom opening 3. In one embodiment, a thumb screw 24 equipped with a threaded end (not shown) is secured to a slide gate bracket 23 and inserted into a threaded opening on the pattern plate 18. The rotation of the thumb screw 24 allows for differential lateral movement of the pattern plate 18 under the bottom opening 3.

FIG. 5 further shows where the peripheral angled tabs 20 with openings on the deflection opening 19 only cover a fraction of the periphery of the deflection opening and deflect only a fraction of the flow of material. In one embodiment shown in FIG. 5, a cascade-like effect is created over the rotatable spreader plate 10.

It will be understood by one of ordinary skill in the art that in the above described configuration relates to an improved broadcast deflector plate designed to create a cascade-like deflection of the material over a series of angled tabs separated by open intervals where indirect flow is created. As illustrated in FIG. 5, a first volume of material falls without deflection directly through the open intervals onto the spreader plate at a first position, and a second volume of material is deflected by the tabs to a preferential location closer to the center of the spreader plate, while the presence of openings between the tabs allows for a third volume of material to cascade in all directions around the tabs and reach all intermediate positions on the spreader plate. The tabs are of sufficient length and width in proportion to the intervals between tabs to create a cascade effect of material in order to effectively deflect the material uniformly over the spreader plate. FIG. 5 is designed to show this effect by illustrating a series of dashed lines corresponding to potential movement of material 7 over the peripheral angled tabs 20.

In an embodiment, the deflection openings are rectangular tabs 20 of square geometry located on a single side of the deflection opening 19. In the configuration illustrated in FIG. 5, the tabs 20 deflect about half of the material 7 at an angle in a range of 15 to 45 degrees from horizontal and preferentially at about 30 degrees from horizontal. It is understood that the geometry and location of the tabs 20 as shown is only one possible embodiment of a deflector plate assembly 14 with peripheral angled tabs 20, but what is contemplated is any deflection system based on tabs allowing a fraction of the material 7 to pass directly onto the rotatable spreader plate 10. The size, geometry, spacing, and deflection angles are to be determined based on the sizes, shapes, and other mechanical characteristics of the particles within the material 7. As a nonlimiting example, if dense, humid soil is used as material 7, the angled tabs need to be sufficiently spaced to allow soil to be deflected by the tabs and the width of the tabs must also be sufficiently thick to deflect the material 7. If a fine, powdered material is used, the tab geometry and spacing may be closer and resemble a fork-like geometry. It is understood by one of ordinary skill in the art that calibration of tabs is achieved without an undue burden associated with experimentation.

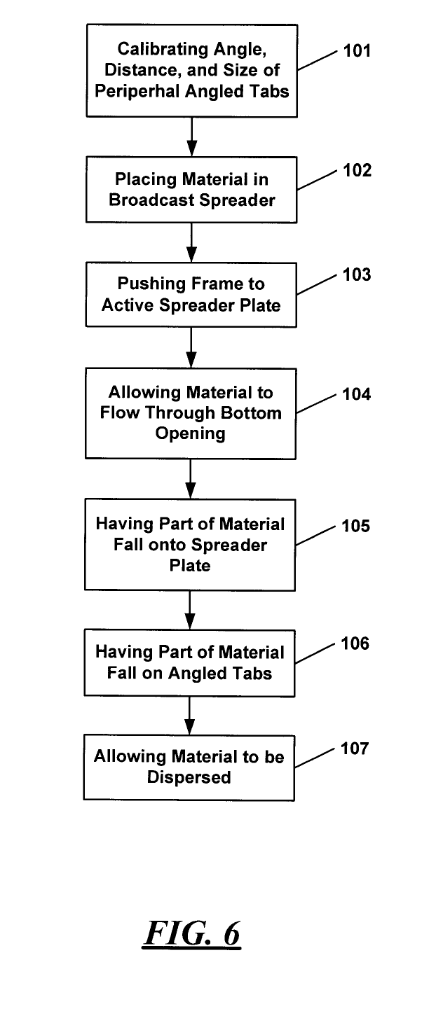

What is also contemplated is a method of spreading material uniformly over a horizontal surface using a broadcast spreader equipped with a deflection plate as described previously and as shown in FIG. 6. The method comprises the steps of calibrating the angle, the interstice distance, and the size of the peripheral angled tabs to create a sufficient section of deflection in the deflection opening 101 based on characteristics of the material to be spread, placing a material in the broadcast spreader 102, pushing the frame in order to activate the rotatable spreader plate 103, allowing the material to flow through the bottom opening 104, having part of the material fall directly onto a first close section of the rotatable spreader plate 105, having part of the material fall on the peripheral angled tabs for redirection onto the second section of the rotatable spreader plate 106, and allowing the material from the first section and the second section on the rotatable spreader plate to be dispersed on a horizontal surface 107.

In one embodiment of the present disclosure, the material is placed in the hopper 2 and the frame 5 is pushed using the handle 6. The flow of material 7 through the broadcast spreader is controlled by the opening of the closure plate 21 in association with the pattern plate 18 as controlled using a lever mechanism and a thumb screw mechanism. It is understood by one of ordinary skill in the art that while this method generally discloses a method of use of the broadcast spreader as disclosed in FIGS. 2-5, the method disclosed is also applicable to other type of broadcast spreaders.

Persons of ordinary skill in the art appreciate that although the teachings of the disclosure have been illustrated in connection with certain embodiments and method, there is no intent to limit the invention to such embodiments and method. On the contrary, the intention of this application is to cover all modifications and embodiments failing fairly within the scope of the teachings of the disclosure.

We claim:

1. A broadcast spreader for distributing material disposed therein, the spreader comprising:
a hopper containing a material, the hopper having an opening defined by a periphery;
a frame for supporting the hopper;
a wheel and axle assembly rotatably connected to the frame so the broadcast spreader can be moved over a surface;
a rotatable spreader plate located below the hopper to spread the material rotating as a result of the wheel and axle assembly being moved over the surface; and
a spreader deflection plate assembly connected to the periphery comprising a guide plate including a flow opening, a guide, a pattern plate disposed in the guide including a deflection opening defined by a deflection periphery having peripheral angled tabs, and a closure plate disposed between the guide plate and the pattern plate,
wherein the closure plate controls a flow of the material from the hopper onto the rotatable spreader plate,
wherein the peripheral angled tabs are disposed on a portion of the deflection periphery such that a portion of the flow of material that passes through the deflection opening is deflected thereby.

2. The broadcast spreader of claim 1, wherein the deflection opening forms a rectangle.

3. The broadcast spreader of claim 2, wherein the peripheral angled tabs are located on a single side of the rectangle.

4. The broadcast spreader of claim 3, wherein the angled tabs are of square geometry.

5. The broadcast spreader of claim 4, wherein the tabs deflect about half of the flow of material.

6. The broadcast spreader of claim 4, wherein the tabs are angled from horizontal at a range of 15 to 45 degrees.

7. The broadcast spreader of claim 4, wherein the tabs are angled from horizontal at about 30 degrees.

8. The broadcast spreader of claim 1, wherein the guide is two lateral L shaped slide rails.

9. A spreader deflection plate assembly, the assembly comprising:
a guide plate comprising a flow opening for the passage of a flow of material, a guide rail including a pattern plate with a periphery disposed therein having a deflection opening and a fixation tab;
a closure plate disposed between the guide plate and the pattern plate,
wherein a control activates the closure plate over the flow opening to control a flow of material between an open position to a closed position,
wherein a fixation device connects the slide gate bracket to the fixation tab to activate control of the deflection opening with respect to the flow opening, and
wherein a portion of the periphery includes peripheral angled tabs able to deflect a portion of the flow of material through the deflection opening.

10. The spreader deflection plate assembly of claim 9, wherein the deflection opening forms a rectangle.

11. The spreader deflection plate assembly of claim 10, wherein the peripheral angled tabs are located on a single side of the rectangle.

12. The spreader deflection plate assembly of claim 11, wherein the angled tabs are of square geometry.

13. The spreader deflection plate assembly of claim 12, wherein the tabs deflect about half of the flow of material.

14. The spreader deflection plate assembly of claim 12, wherein the tabs are angled from horizontal at a range of 15 to 45 degrees.

15. The spreader deflection plate assembly of claim 12, wherein the tabs are angled from horizontal at about 30 degrees.

16. The spreader deflection plate assembly of claim 10, wherein the guide is two lateral L shaped slide rails.

17. The spreader deflection plate assembly of claim 10, wherein the fixation means is a rivet and a thumb screw.

18. The spreader deflection plate assembly of claim 10, wherein the control means is a u shaped slider.

19. A method of spreading uniformly a material over a horizontal surface using a broadcast spreader, the broadcast spreader comprising a hopper containing a material, the hopper having an opening defined by a periphery, a frame for supporting the hopper, a wheel and axle assembly rotatably connected to the frame so the broadcast spreader can be moved over a surface, a rotatable spreader plate located below the hopper to spread the material rotating as a result of the wheel and axle assembly being moved over the surface; and a spreader deflection plate assembly connected to the periphery comprising a guide plate including a flow opening, a guide, a pattern plate disposed in the guide including a deflection opening defined by a deflection periphery having peripheral angled tabs, and a closure plate disposed between the guide plate and the pattern plate, the method comprising the steps of:
calibrating the angle, the distance, and the size of the peripheral angled tabs to create a sufficient section of deflection in the deflection opening, placing a material in the broadcast spreader;
pushing the frame in order to activate the rotatable spreader plate;
allowing the material to flow through the bottom opening;
having part of the material to fall directly onto a first section of the rotatable spreader plate;
having part of the material fall on the peripheral angled tabs for redirection onto a second outer section of the rotatable spreader plate;
transferring the material from the first section and the second outer section on the rotatable spreader plate on a horizontal surface for dispersion of the material.

20. A method of spreading uniformly a material over a horizontal surface using a broadcast spreader of claim 19, wherein the deflection opening forms a rectangle.

21. A method of spreading uniformly a material over a horizontal surface using a broadcast spreader of claim 20, wherein the peripheral angled tabs are located on a single side of the rectangle.

22. A method of spreading uniformly a material over a horizontal surface using a broadcast spreader of claim 19, wherein the angled tabs are of square geometry.

23. A method of spreading uniformly a material over a horizontal surface using a broadcast spreader of claim 22, wherein the tabs deflect about half of the flow of material.

24. A method of spreading uniformly a material over a horizontal surface using a broadcast spreader of claim 22, wherein the tabs are angled from horizontal at a range of 15 to 45 degrees.

25. A method of spreading uniformly a material over a horizontal surface using a broadcast spreader of claim 24, wherein the tabs are angled from horizontal at about 30 degrees.
